(19) United States
(12) Patent Application Publication
(10) Pub. No.: US 2026/0064858 A1
(43) Pub. Date: Mar. 5, 2026

(54) Isolation-Based Confidentiality

(71) Applicant: Advanced Micro Devices, Inc., Santa Clara, CA (US)

(72) Inventors: Shaizeen Dilawarhusen Aga, Santa Clara, CA (US); Nuwan S. Jayasena, Cupertino, CA (US); David A. Kaplan, Austin, TX (US); Varun Agrawal, Westford, MA (US); Sooraj Puthoor, Austin, TX (US)

(73) Assignee: Advanced Micro Devices, Inc., Santa Clara, CA (US)

(21) Appl. No.: 18/820,013

(22) Filed: Aug. 29, 2024

(51) Int. Cl. G06F 21/60

(52) U.S. Cl. CPC G06F 21/602

(57) ABSTRACT

Systems and techniques for isolation-based confidentiality are described. In one example, a processor is communicatively coupled to memory accessible by multiple applications. The processor requests a private memory region in the memory for data of a first application of the multiple applications. The processor causes the data of the first application to be stored in the private memory region without encryption (e.g., in an unencrypted format). The data in the private memory region is not accessible by the other applications of the processor or other processors. In this way, confidentiality is provided for sensitive data without the overhead required of traditional encryption techniques.

Computer systems use confidentiality mechanisms to ensure that only the owning application can access its data, while other applications cannot. Confidentiality is typically achieved through encryption. For example, a common encryption technique involves using a block cipher to encrypt an application's data with a secret key known only to the application. Such cipher methods require application keys to be securely provisioned and managed in hardware for each application. Furthermore, encryption-based confidentiality schemes store data in an encrypted form, requiring decryption before use, which adds overhead to data processing and memory usage. These challenges are amplified for new computer technologies, such as processing-in-memory.

### BRIEF DESCRIPTION OF THE DRAWINGS

FIG. 1 is a block diagram of an example system that includes a host with a core and a memory module that implement isolation-based confidentiality.

FIG. 2 depicts a block diagram of an example system that enables isolation-based confidentiality.

FIG. 3 depicts a procedure in an example implementation of hardware-based data scrubbing to support isolation-based confidentiality.

FIG. 4 depicts a procedure in an example implementation of isolation-based confidentiality.

FIG. 5 is a block diagram of a processing system configured to execute one or more applications in accordance with one or more implementations.

### DETAILED DESCRIPTION

Data confidentiality is generally achieved through encryption. Secure encryption is typically implemented using a block cipher, with the advanced encryption standard (AES) being a common choice. Each application encrypts its data using a secret key known only to that application, which necessitates the provisioning and secure management of keys for each application in secure hardware.

Block-based ciphers, such as AES, work with fixed block sizes (e.g., cache blocks). When a cache block is written to memory, data is encrypted using the corresponding application's secret key through AES operations and then stored in memory. When data is read, the data is decrypted using the same secret key. Therefore, any other application attempting to read the data without access to the secret key only sees random garbage bits.

This conventional encryption mechanism introduces AES operations on the critical path for each cache-block memory access. Additionally, counter-based encryption techniques, like counter-mode encryption, require metadata bits per cache block (e.g., counter value). These secret keys and metadata reduce the available memory capacity, particularly for emerging workloads, such as machine-learning inference.

Encryption-based confidentiality schemes also pose a challenge to disruptive technologies, such as processing-in-memory (PIM), because they reduce the advantages thereof. PIM involves placing compute units inside memory, leading to a significant increase in memory bandwidth for memory-bound computations by offloading compute tasks from a processor device to these compute units. These computations are often crucial bottlenecks in machine-learning and artificial intelligence workloads. The memory bandwidth boost in PIM-enabled systems can accelerate machine-learning workloads by more than four times. However, with encryption, data is stored in memory in encrypted form, requiring it to be decrypted in memory for PIM computations. The decryption step adds overhead to PIM execution and greatly diminishes PIM acceleration.

The described isolation-based techniques use trusted memory modules to provide confidentiality without requiring full memory encryption. These techniques include mechanisms to enhance memory with the ability to scrub data when directed by a processor, augment memory controllers to perform range scrubs, and utilize compute units (e.g., PIM components) associated with memory units to accelerate memory scrub operations. Necessary precautions, such as scrubbing, ensure data confidentiality without the overhead costs of conventional encryption techniques. As a result, the isolation-based techniques provide isolation and metadata at the page or memory-region level on the critical path instead of on the cache-block level, per-component key management instead of per-application key management, and minimal impact on PIM acceleration.

In one example, a processor is communicatively coupled to memory accessible by multiple applications. The processor requests a private memory region in the memory for data of the first application of the multiple applications. The processor causes the data of the first application to be stored in the private memory region without encryption (e.g., in an unencrypted format). The data in the private memory region is not accessible by the other applications of the processor or other processors. In this way, confidentiality is provided for sensitive data without the overhead required of traditional encryption techniques.

In some aspects, the techniques described herein relate to a system including a processor configured to request a private memory region in memory for data of a first application of multiple applications and cause the data of the first application to be stored in the private memory region without encryption, the data not being accessible by other applications of the processor.

In some aspects, the techniques described herein relate to a system wherein the private memory region of the memory is defined at a page level or as a range of memory addresses.

In some aspects, the techniques described herein relate to a system wherein the processor is further configured to request a shared memory region accessible by the first application and a second application of the multiple applications.

In some aspects, the techniques described herein relate to a system wherein the processor is further configured to cause scrubbing of the data in the private memory region in response to an indication that the private memory region has transitioned to a shared memory region.

In some aspects, the techniques described herein relate to a system wherein the scrubbing is initiated by a compute unit in or near the memory.

In some aspects, the techniques described herein relate to a system wherein the scrubbing comprises writing zero values to each data value in the private memory region.

In some aspects, the techniques described herein relate to a system wherein the scrubbing comprises writing random values to each data value in the private memory region.

In some aspects, the techniques described herein relate to a system wherein the processor is further configured to cause scrubbing of the data in the private memory region in response to an indication of a transition of the private memory region from shared memory to private memory.

In some aspects, the techniques described herein relate to a system wherein access requests to the private memory region are prevented until the scrubbing is completed.

In some aspects, the techniques described herein relate to a system wherein the access requests are prevented by ordering the access requests to occur after completion of the scrubbing.

In some aspects, the techniques described herein relate to a system wherein the processor is further configured to establish a trust boundary with a memory system through mutual authentication and attestation.

In some aspects, the techniques described herein relate to a system wherein the processor is further configured to transfer, on behalf of the first application, the data to the private memory region using link encryption to encrypt the data for transmission over a link between the processor and the private memory region.

In some aspects, the techniques described herein relate to a method that includes receiving, by a processor, a request from a first application to establish a private memory region in memory for data of the first application, requesting, by the processor, a private memory region for the data of the first application to be established in the memory, the private memory region not being accessible by other applications of the processor, and causing, by the processor, the data of the first application to be stored in the private memory region in an unencrypted state.

In some aspects, the techniques described herein relate to a method that further includes causing, by a memory controller, scrubbing of the private memory region in response to an indication of a power cycling of the memory.

In some aspects, the techniques described herein relate to a method wherein the scrubbing comprises writing zero values, one values, or random values to each data value in the private memory region.

In some aspects, the techniques described herein relate to a method that further includes causing, by the memory, scrubbing of the private memory region in response to a detection of a new attestation and authentication request from the processor.

In some aspects, the techniques described herein relate to a system comprising a host device with one or more processor cores configured to request a private memory region for data of one or more applications of multiple applications, and a memory device communicatively coupled to the host device, the memory device comprising a memory unit configured to store the data of the first application in a private memory region in an unencrypted format, the data not being accessible by other applications of the multiple applications.

In some aspects, the techniques described herein relate to a system wherein the private memory region is distributed across multiple memory units of the memory device, and the memory device further comprises a compute unit in or near the multiple memory units that is configured to cause scrubbing of the data in the private memory region across the multiple memory units in response to an indication that the private memory region has transitioned to a shared memory region.

In some aspects, the techniques described herein relate to a system wherein the scrubbing is performed in the multiple memory units in parallel and in response to a single command from one or more processor cores.

In some aspects, the techniques described herein relate to a system wherein the scrubbing is performed in the multiple memory units for a range of memory addresses associated with the private memory region.

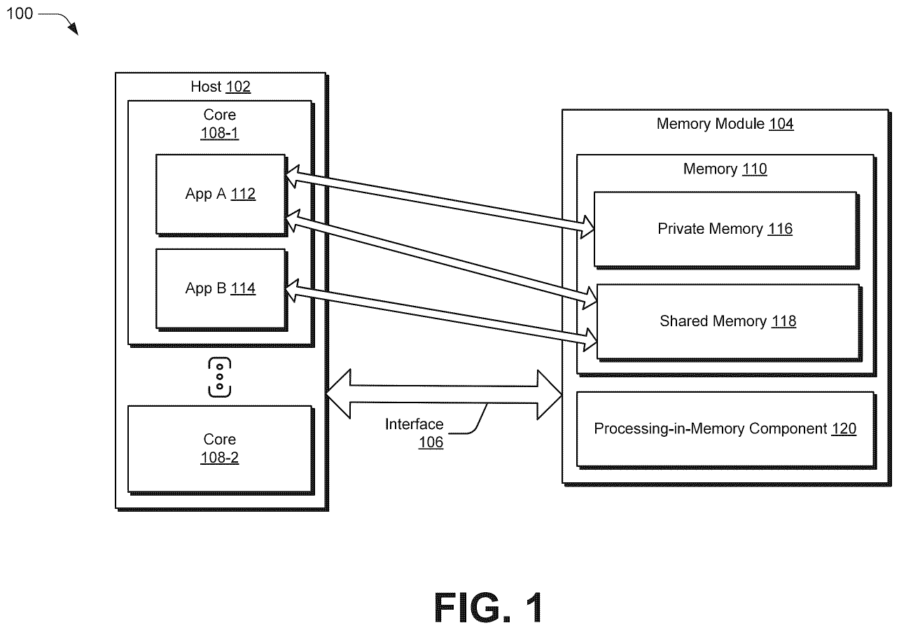

FIG. 1 is a block diagram of an example system 100 that includes a host with a core and a memory module that implement isolation-based confidentiality. In particular, the system 100 includes a host 102 and a memory module 104 communicatively coupled via interface 106. In one or more implementations, the host 102 includes at least one core 108. In some implementations, the host 102 includes multiple cores 108. For instance, in the illustrated example of FIG. 1, host 102 is depicted as including core 108-1 and core 108-2. In alternate embodiments, system 100 includes fewer or more cores 108. The memory module 104 includes memory 110.

In accordance with the described techniques, the host 102 and the memory module 104 are coupled to one another via a wired or wireless connection, which is depicted in the illustrated example of FIG. 1 as the interface 106. Example wired connections include, but are not limited to, buses (e.g., a data bus), interconnects, traces, and planes. Examples of devices in which the system 100 is implemented include, but are not limited to, supercomputers and/or computer clusters of high-performance computing (HPC) environments, servers, data center servers, personal computers, laptops, desktops, game consoles, set-top boxes, tablets, smartphones, mobile devices, virtual and/or augmented reality devices, wearables, medical devices, systems on chips, and other computing devices or systems.

The host 102 is an electronic circuit that performs various operations on and/or using data in the memory 110. Examples of the host 102 and/or the cores 108 include but are not limited to a system on chip (SoC), central processing unit (CPU), graphics processing unit (GPU), field programmable gate array (FPGA), accelerated processing unit (APU), and digital signal processor (DSP). For example, cores 108 are processing units that read and execute instructions (e.g., of a program or application), examples of which include adding, subtracting, or moving data, branching, and so forth.

In one or more implementations, the memory module 104 is a circuit board (e.g., a printed circuit board), on which the memory 110 is mounted. In some variations, one or more integrated circuits of the memory 110 are mounted on the circuit board of the memory module 104, and the memory module 104 includes one or more processing-in-memory components. Examples of the memory module 104 include, but are not limited to, a TransFlash memory module, a single in-line memory module (SIMM), and a dual in-line memory module (DIMM). In one or more implementations, the memory module 104 is a single integrated circuit device that incorporates the memory 110 on a single chip. In some examples, the memory module 104 is composed of multiple chips that implement the memory 110 and the processing-in-memory component 120 that are vertically (“3D”) stacked together, placed side-by-side on an interposer or substrate, or assembled via a combination of vertical stacking and side-by-side placement.

The memory 110 is a device or system used to store information, such as for immediate use in a device (e.g., by the cores 108 of the host 102). In one or more implementations, the memory 110 corresponds to semiconductor memory where data is stored within memory cells on one or more integrated circuits. In at least one example, the memory 110 corresponds to or includes volatile memory, examples of which include random-access memory (RAM), dynamic random-access memory (DRAM), synchronous dynamic random-access memory (SDRAM), and static random-access memory (SRAM).

In some implementations, the memory 110 represents high bandwidth memory (HBM) in a 3D-stacked implementation. Alternatively or additionally, the memory 110 corresponds to or includes non-volatile memory, examples of which include solid state disks (SSD), flash memory, read-only memory (ROM), programmable read-only memory (PROM), erasable programmable read-only memory (EPROM), and electronically erasable programmable read-only memory (EEPROM). The memory 110 is thus configurable in various ways that support using data stored in memory (e.g., of the memory 110) or processing-in-memory, without departing from the spirit or scope of the described techniques.

The core 108-1 is depicted as hosting one or more applications or processes, including Application A 112 and Application B 114. Although described herein in the context of applications, Application A 112 and Application B 114 represent any suitable configuration of one or more processes, threads, or routines executing instructions by accessing data stored in memory 110.

The memory 110 is depicted as including a private memory 116 and a shared memory 118. The private memory 116 and shared memory 118 represent different regions, sections, or slices of memory 110 with different access privileges for the applications of the core 108-1 (e.g., Application A 112 and Application B 114). For example, the memory regions are definable at a page level, a range of memory addresses, or by other granularity within memory 110.

Once a memory region is marked as private memory 116, any read or write access requests from any application (e.g., Application B 114), including an operating system or virtual machine monitor, other than the owner (e.g., Application A 112), are prevented by the host 102. As a result, Application A 112 maintains the confidentiality of certain data without employing encryption techniques in storing and accessing that data. In contrast, data stored in shared memory 118 is accessible by any application, including Application A 112 and Application B 114. In the illustrated example, Application A 112 requests certain data be stored in private memory 116 and the rest of accessible data in shared memory 118. Once this section of memory 110 is marked as private memory 116, Application A 112 can access the data, but Application B 114 cannot. In this way, memory 110 ensures data confidentiality in a less granular (e.g., per page or address ranges) and more robust manner than conventional encryption techniques that often require encryption operations at the cache-block level, resulting in lower overhead to maintain this confidentiality.

It is noted that in some embodiments, one or more of the functions described above for the core 108-1 is additionally or alternatively performed by the core 108-2 or other computing units in the system 100. For example, the core 108-2 can request a region of memory 110 be marked as private memory 116 for a certain subset of its data.

The memory module 104 also includes a processing-in-memory component 120, which is an example of an accelerator or other near-memory compute unit utilized by the host 102 to offload the performance of computations (e.g., computations that would otherwise be performed by the cores 108 in a conventional computing device architecture). In other implementations, the processing-in-memory component 120 is replaced by a variety of different accelerator configurations (e.g., a near-memory compute unit, an arithmetic logic unit, or another accelerator unit). The processing-in-memory component 120 is configured to process processing-in-memory instructions (e.g., received from the cores 108 via the interface 106) and is representative of a processing unit or processor with example processing capabilities ranging from relatively simple (e.g., an adding machine) to relatively complex (e.g., a CPU/GPU compute core). For example, the processing-in-memory component 120 includes hardware (e.g., circuitry) physically located at or near the memory 110 and wired to perform logic functions (e.g., datacasting logic or collective memory access logic) and/or to execute program instructions. For example, the processing-in-memory component 120 processes instructions using data stored in memory 110.

Processing-in-memory contrasts with standard computer architectures, which obtain data from memory, communicate the data to a remote processing unit (e.g., the cores 108 of the host 102), and process the data using the remote processing unit (e.g., using the core 108 rather than the processing-in-memory component 120). In various scenarios, the data produced by the remote processing unit as a result of processing the obtained data is written back to memory, which involves communicating the produced data over the interface 106 from the remote processing unit to memory. In terms of data communication pathways, the remote processing unit (e.g., the cores 108 of the host 102) is further away from the memory 110 than the processing-in-memory component 120, both physically and topologically. As a result, conventional computer architectures suffer from increased data transfer latency, reduced data communication bandwidth, and increased data communication energy, particularly when the volume of data transferred between the memory and the remote processing unit is large, which can also decrease overall computer performance.

Thus, the processing-in-memory component 120 enables increased computer performance while reducing data transfer energy compared to standard computer architectures that implement remote processing hardware. Further, the processing-in-memory component 120 alleviates memory performance and energy bottlenecks by moving one or more memory-intensive computations closer to the memory 110. Although the processing-in-memory component 120 is illustrated as being disposed within the memory module 104, in some examples, the described benefits of triggering processing-in-memory commands are extendable to near-memory processing implementations in which an accelerator is located closer to the memory 110 (e.g., in terms of data communication pathways) than the cores 108 of the host 102.

Returning to the private memory 116 and the shared memory 118 scenario described above, the host 102 sends or forwards compute requests to the processing-in-memory component 120 if the requesting application has access to the memory region associated with the compute requests. For example, if Application A 112 sends or offloads compute tasks associated with the private memory 116 (or the shared memory 118), the host 102 (or the core 108-1) sends the compute tasks to the processing-in-memory component 120 after verifying that Application A 112 has access to the private memory 116 (or the shared memory 118). In contrast, the host 102 does not send compute tasks to the processing-in-memory component 120 from Application B 114 if those compute tasks are associated with or access data in the private memory 116. In this way, the host 102 ensures continued isolation-based confidentiality of data in private memory 116 while utilizing the acceleration boost of processing in memory configurations.

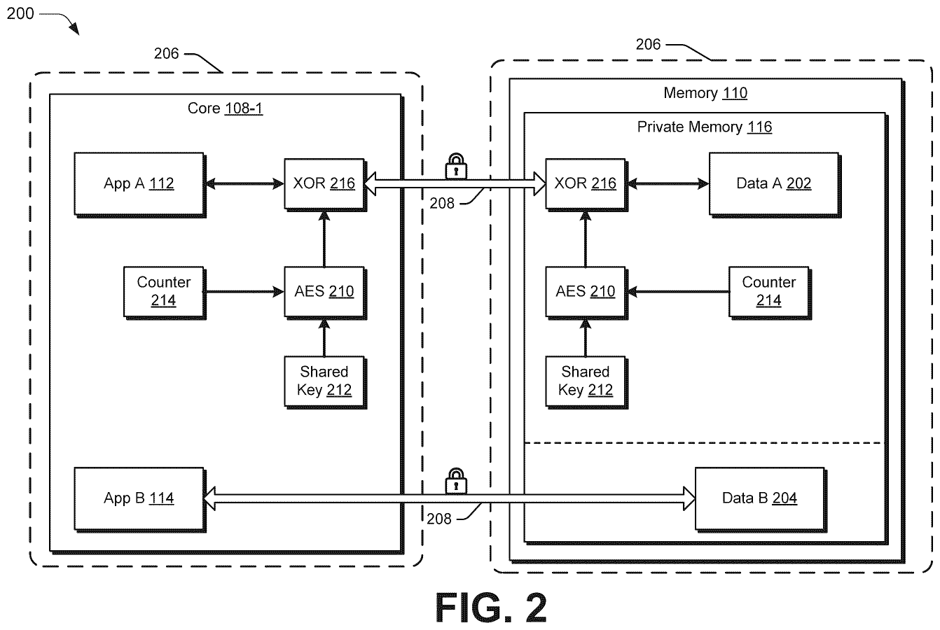

FIG. 2 depicts a block diagram of an example system 200 that enables isolation-based confidentiality. The system 200 includes the core 108-1, memory 110, and private memory 116 of FIG. 1. In particular, FIG. 2 illustrates a scenario where the core 108-1 includes Application A 112 and Application B 114. Application A 112 stores Data A 202 in private memory 116 of memory 110, while Application B 114 stores Data B 204 in private memory 116.

As discussed, encryption-based confidentiality schemes use per-application secret keys (e.g., Key A and Key B for Application A 112 and Application B 114, respectively) and block-based AES cipher operations. The block-based AES cipher operations are generally employed for each cache block to encrypt data on write requests and decrypt the data on read requests using the corresponding per-application secret key. While a non-owner process can read the data, no information is leaked to this application without access to the owner's secret key. In other words, garbage bits are returned to a read request without the secret key associated with the data.

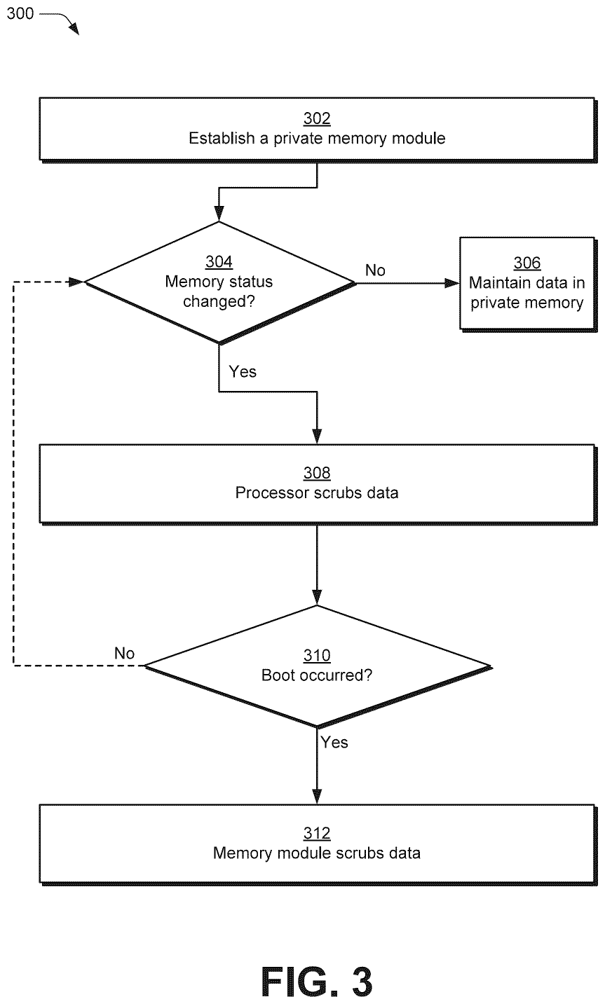

In contrast, the described isolation-based techniques utilize hardware-enforced isolation and trusted memory modules to ensure confidentiality. In other words, a non-owner application is prevented from issuing access requests (e.g., read and write operations) to another application's data in private memory 116 through mutual authentication and attestation. In the illustrated example, Application A 112 stores Data A 202 in a first portion of private memory 116 and Application B 114 stores Data B 204 in a second portion of private memory 116. Here, the first and second portions are illustrated as different portions of the same private memory 116. In other implementations, the first and second portions are distinct instances of the private memory 116. Data A 202 is accessible (e.g., for read or write requests) to Application A 112, but not Application B 114. Similarly, Data B 204 is accessible to Application B 114, but not Application A 112. In addition, on each transition of shared memory 118 to private memory 116 or before allocation of private memory 116 to another application or another core 108, a scrubbing operation is utilized, described in greater detail with respect to FIG. 3. In this way, confidentiality is ensured without encryption and its associated challenges by creating a trust boundary 206 around the core 108-1 and the memory 110.

Between components within the trust boundaries 206, the described isolation-based techniques also utilize link encryption (e.g., Advanced Encryption Standard (AES)-Counter Mode encryption) over a memory bus 208 to secure data. The link encryption is realized inexpensively with an AES algorithm 210, shared key 212, counter 214, and XOR operator 216, but with strong encryption. In this way, heavy-weight AES operations are removed from critical paths for each cache block and instead just an XOR operation is added. Different encryption techniques can be utilized for the link encryption over the memory bus 208 in other implementations.

The AES algorithm 210 is a symmetric block cipher that operates on data blocks using the shared key 212 to encrypt and decrypt the data therein through a series of substitutions and permutations. The core 108-1 and the memory 110 utilize the same AES algorithm 210. The shared key 212 is a secret key shared by the core 108-1 and the memory 110 as the main input for the AES algorithm 210. The shared key 212 acts like a password that defines the transformation process for encrypting and decrypting data blocks. In other words, the AES algorithm 210 uses the shared key 212 (along with the counter 214) to generate a keystream block.

The counter 214 is a shared counter value that is incremented for each data block being encrypted. The counter 214 ensures that the keystream block generated by the AES algorithm 210 is not repeated, even for identical plaintexts (e.g., Data A 202). The counter 214 is often combined (e.g., using an XOR or exclusive OR operation) with a random nonce (or number used once) to ensure unique keystream blocks. The nonce is essentially an initialization value for the counter 214. Using the counter 214 with the AES algorithm 210, allows for stream encryption, where data is processed (e.g., encrypted or decrypted) in a continuous stream of bits or bytes as opposed to fixed-size blocks of data.

The XOR operator 216 (or exclusive OR operator) is a bitwise operation that takes two inputs and outputs a single output. The XOR operator 216 performs an exclusive XOR operation with the plaintext block (e.g., Data A 202) to produce the ciphertext block transmitted over the memory bus 208. In particular, the encryption process begins with the counter 214 being combined (e.g., using a bitwise operation like XOR) with a fixed nonce to create a unique value or input for each data block or data stream. This combined value is then fed into the AES algorithm 210 along with the shared key 212 to generate a keystream block of the same size as the data block. In other words, the AES algorithm 210 uses the shared key 212 to operate on the combined counter-nonce value and output the keystream block. The plaintext block (e.g., Data A 202) is XORed with the generated keystream block to produce the ciphertext block.

The decryption process involves the reverse process. The keystream block is generated using the same counter-nonce combination, shared key 212, and AES algorithm 210 as the encryption process. The ciphertext block is then XORed with the generated keystream block to recover the original plaintext block (e.g., Data A 202). A similar encryption and decryption process is used by Application B 114 for Data B 204 using a unique shared key and counter. In other implementations, Application B 114 using the same shared key as used by Application A 112.

FIG. 3 depicts a procedure 300 in an example implementation of hardware-based data scrubbing to support isolation-based confidentiality. Preventing access requests (e.g., read or write operations) from non-owner applications to data in private memory 116 provides confidentiality during execution. However, cold-boot attacks still render unencrypted data in the private memory 116 vulnerable to disclosure. The described isolation-based techniques employ data scrubbing on a power cycling, boot, or memory transition to render such attacks ineffective. Hardware-assisted scrubbing by the trusted processor (e.g., core 108-1) and the trusted memory (e.g., private memory 116) enables data confidentiality without encryption and the associated challenges.

Procedure 300 begins with establishing a private memory module (e.g., private memory 116) (block 302). The core 108-1 determines whether the memory status of the private memory 116 has changed from private to shared memory or vice-versa (block 304). If the memory status has not changed (e.g., a “No” determination at block 304), then the core 108-1 maintains the confidential data (e.g., Data A 202 of Application A 112) in the private memory 116 (block 306).

If the memory status has changed (e.g., a “Yes” determination at block 304), then the trusted processor (e.g., core 108-1) scrubs the data in the memory region formerly associated with the private memory 116 (block 308). Scrubbing a page, range of addresses, or other memory region causes a predetermined value (e.g., zeroes) or random values (e.g., a random combination of ones and zeroes) to be written to all locations therein. While the scrub operation is underway, the memory 110 prevents any access requests (e.g., reads or writes) to the memory region being scrubbed. In one implementation, the prevention of access requests is enabled by locking the memory region via setting bits in an associated page table. In another implementation, the memory 110 orders or schedules any read or write requests to occur after the write operation (e.g., replacing each confidential bit with zeroes) of the scrub routine. In other implementations, the trusted processor (e.g., the core 108-1) tracks which memory regions have been scrubbed in tandem with an operating system to prevent scrubbing on a critical path.

In other implementations, scrub operations are also realized using a new scrub instruction specifying the address range. Components in the memory sub-system (e.g., caches, memory controllers, networks) are set up to ensure that any subsequent conflicting access requests to addresses being scrubbed are ordered after the scrub operation is completed, allowing access requests to other memory regions to proceed and not be blocked or delayed. For example, a memory controller manages scrub operations and issues fine-grained scrub write operations as necessary. By not issuing fine-grain scrub write operations from the cores 108 and instead issuing them at or near the memory controller, interference to other memory traffic between the host 102 and the memory module 104 is avoided, and energy savings are realized by moving data a shorter distance.

In some scenarios, an operating system swaps a physical memory page to disk to better manage memory between active processes or applications. This swap triggers a deallocation of that memory page from the application. In such cases, the memory page is copied to disk not to lose its contents, which also qualifies as a classification transition (e.g., a “Yes”determination at block 304) triggering a scrub operation.

The memory 110 determines whether a cold boot or power cycle has occurred (block 310). If a boot has not occurred (a “No” determination at block 310), then the procedure returns to block 304. If a boot has occurred (a “Yes” determination at block 310), the memory 110 scrubs the private memory 116 (block 312). Memory scrubbing on a power cycle is important to maintain data confidentiality against cold-boot attacks.

A controller detects power cycling of memory (e.g., memory 110), which indicates a potential cold-boot attack, and performs a scrub of the private memory 116. If memory 110 sets sensitive data to be stored in a specified and static portion of memory, the scrub operation only occurs in that specified region to lower the amount of memory needing to be scrubbed at boot time. In some implementations, the memory 110 also scrubs the private memory 116 in response to detecting a new attestation and authentication request from a processing unit (e.g., core 108-2).

Additionally, processing-in-memory techniques are exploited to accelerate memory scrubbing. A compute unit (e.g., processing-in-memory component 120) can be placed in or near memory units (e.g., DRAM banks and subarrays). Unlike access requests from the host 102 or core 108-1 that access a single DRAM bank in a DRAM channel, these compute units can broadcast a single command (e.g., scrub operation) to multiple DRAM units (e.g., the private memory 116 is distributed across multiple DRAM units), enabling multiple DRAM units to be scrubbed in parallel and deliver considerable acceleration (e.g., about 8× acceleration in LPDDR devices with 16 banks per DRAM channel and an arithmetic logic unit (ALU) per DRAM bank). The near-memory ALUs are augmented in some implementations with scrub functionalities (e.g., write with a constant pre-configured value or a random-generated value) to accelerate bulk scrubbing, especially for memory scrubs at boot time.

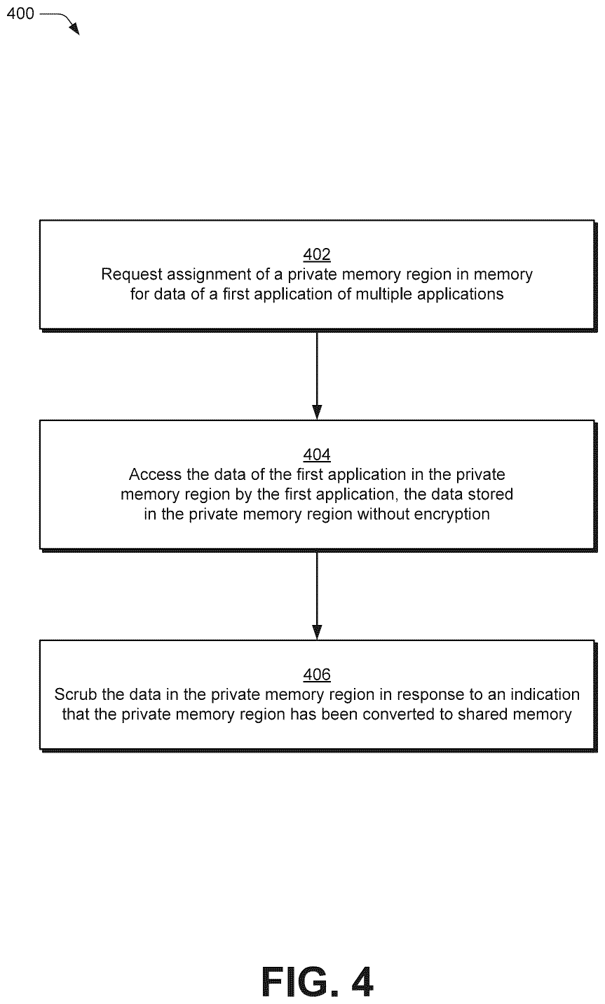

FIG. 4 depicts a procedure 400 in an example implementation of isolation-based confidentiality. In procedure 400, a processor requests assignment of a private memory region in memory for data of a first application of multiple applications executing on the processor (block 402). For example, Application A 112 and Application B 114 are hosted on the core 108-1, which requests that data associated with Application A 112 be stored in private memory 116.

The first application accesses the data in the private memory region (block 404). The data is stored in the private memory region without encryption or in an unencrypted format. For example, the data of Application A 112 is stored in the private memory 116 in an unencrypted format, but Application B 114 is not granted access to this data by the core 108-1.

In response to an indication that the private memory region has been converted to shared memory (e.g., shared by the multiple applications of the processor and/or other processors), the processor causes the data in the (formerly) private memory region to be scrubbed (block 406). For example, Application A 112 or the core 108-1 causes the data in the private memory 116 to be replaced with zeroes (or another value) to scrub this memory region of the confidential data.

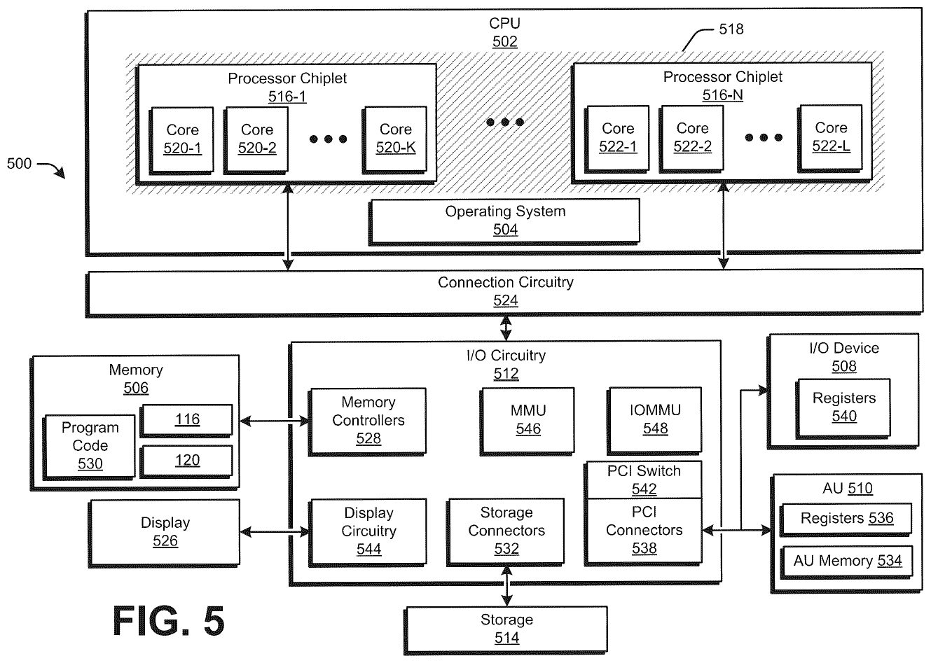

FIG. 5 is a block diagram of a processing system configured to execute one or more applications in accordance with one or more implementations. In particular, FIG. 5 includes a processing system 500 configured to execute one or more applications, such as computing applications (e.g., machine-learning applications, neural network applications, high-performance computing applications, databasing applications, gaming applications), graphics applications, and the like. Examples of devices in which the processing system 500 is implemented include but are not limited to a server computer, personal computer (e.g., desktop or tower computer), smartphone or another wireless phone, tablet or phablet computer, notebook computer, laptop computer, wearable device (e.g., smartwatch, augmented reality headset or device, virtual reality headset or device), entertainment device (e.g., gaming console, portable gaming device, streaming media player, digital video recorder, music or another audio playback device, television, set-top box), Internet of Things (IoT) device, automotive computer or computer for another type of vehicle, networking device, medical device or system, and other computing devices or systems.

In the illustrated example, the processing system 500 includes a central processing unit (CPU) 502. In one or more implementations, the CPU 502 is configured to run an operating system (OS) 504 that manages the execution of applications. For example, the OS 504 is configured to schedule the execution of tasks (e.g., instructions) for applications, allocate portions of resources (e.g., system memory 506, CPU 502, input/output (I/O) device 508, accelerator unit (AU) 510, storage 514) for the execution of tasks for the applications, provide an interface to I/O devices (e.g., I/O device 508) for the applications, or any combination thereof.

The CPU 502 includes one or more processor chiplets 516, which are communicatively coupled by a data fabric 518 in one or more implementations. Each processor chiplet 516, for example, includes one or more processor cores 520, 522 configured to execute one or more series of instructions concurrently, also referred to herein as “threads” or workloads, for an application. Further, the data fabric 518 communicatively couples each processor chiplet 516-N of the CPU 502 such that each processor core (e.g., processor cores 520) of a first processor chiplet (e.g., 516-1) is communicatively coupled to each processor core (e.g., processor cores 522) of one or more other processor chiplets 516.

Though the example embodiment in FIG. 5 shows a first processor chiplet (516-1) having three processor cores (520-1, 520-2, 520-K) representing a K number of processor cores 522 and a second processor chiplet (516-N) having three processor cores (e.g., 522-1, 522-2, 522-L) representing an L number of processor cores 522, in other implementations (L being an integer number greater than or equal to one), each processor chiplet 516 may have any number of processor cores 520, 522. For example, each processor chiplet 516 can have the same number of processor cores 520, 522 as one or more other processor chiplets 516, a different number of processor cores 520, 522 as one or more other processor chiplets 516, or both.

Examples of connections that are usable to implement the data fabric 518 include but are not limited to buses (e.g., a data bus, a system, an address bus), interconnects, memory channels, and silicon vias, traces, and planes. Other example connections include optical connections, fiber optic connections, and/or connections or links based on quantum entanglement.

Additionally, within the processing system 500, the CPU 502 is communicatively coupled to an I/O circuitry 512 by a connection circuitry 524. For example, each processor chiplet 516 of the CPU 502 is communicatively coupled to the I/O circuitry 512 by the connection circuitry 524. The connection circuitry 524 includes, for example, one or more data fabrics, buses, buffers, queues, and the like. The I/O circuitry 512 is configured to facilitate communications between two or more components of the processing system 500 such as between the CPU 502, system memory 506, display 526, universal serial bus (USB) devices, peripheral component interconnect (PCI) devices (e.g., I/O device 508, AU 510), storage 514, and the like.

As an example, system memory 506 includes any combination of one or more volatile memories and/or one or more non-volatile memories, examples of which include dynamic random-access memory (DRAM), static random-access memory (SRAM), non-volatile RAM, and the like. To manage access to the system memory 506 by CPU 502, the I/O device 508, the AU 510, and/or any other components, the I/O circuitry 512 includes one or more memory controllers 528. The memory controllers 528, for example, include circuitry configured to manage and fulfill memory access requests issued from the CPU 502, the I/O device 508, the AU 510, or any combination thereof. Examples of such requests include read requests, write requests, fetch requests, pre-fetch requests, or any combination thereof. That is to say, the memory controllers 528 are configured to manage access to the data stored at one or more memory addresses within the system memory 506, such as by CPU 502, I/O device 508, and/or AU 510.

In this example, the private memory 116 and processing-in-memory component 120 are depicted in the system memory 506. As described above, private memory 116 is accessible by applications of the cores 520 or cores 522 or processing-in-memory components 120 within the trust boundary associated with the private memory 116. In at least one implementation, the private memory 116 or portions thereof are included in at least two of the depicted components of the processing system 500.

When an application is to be executed by processing system 500, the OS 504 running on the CPU 502 is configured to load at least a portion of program code 530 (e.g., an executable file) associated with the application from, for example, a storage 514 into system memory 506. This storage 514, for example, includes non-volatile storage such as flash memory, solid-state memory, hard disk, optical disc, or the like configured to store program code 530 for one or more applications.

To facilitate communication between the storage 514 and other components of processing system 500, the I/O circuitry 512 includes one or more storage connectors 532 (e.g., universal serial bus (USB) connectors, serial AT attachment (SATA) connectors, PCI Express (PCIe) connectors) configured to communicatively couple storage 514 to the I/O circuitry 512 such that I/O circuitry 512 is capable of routing signals to and from the storage 514 to one or more other components of the processing system 500.

In association with executing an application, in one or more scenarios, the CPU 502 is configured to issue one or more instructions (e.g., threads) to be executed for an application to the AU 510. The AU 510 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 510 includes one or more compute units that concurrently execute one or more threads of an application and store data resulting from the execution of these threads in AU memory 534. This AU memory 534, for example, includes any combination of one or more volatile memories and/or non-volatile memories, examples of which include caches, video RAM (VRAM), or the like. In one or more implementations, these compute units are also configured to execute these threads based on the data stored in one or more physical registers 536 of the AU 510.

To facilitate communication between the AU 510 and one or more other components of processing system 500, the I/O circuitry 512 includes or is otherwise connected to one or more connectors, such as PCI connectors 538 (e.g., PCIe connectors) each including circuitry configured to communicatively couple the AU 510 to the I/O circuitry such that the I/O circuitry 512 is capable of routing signals to and from the AU 510 to one or more other components of the processing system 500. Further, the PCIe connectors 538 are configured to communicatively couple the I/O device 508 to the I/O circuitry 512 such that the I/O circuitry 512 is capable of routing signals to and from the I/O device 508 to one or more other components of the processing system 500.

By way of example and not limitation, the I/O device 508 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 508 is configured to execute one or more operations, tasks, instructions, or any combination thereof based on one or more physical registers 540 of the I/O device 508. In one or more implementations, such physical registers 540 are configured to maintain data (e.g., operands, instructions, values, variables) indicating one or more operations, tasks, or instructions to be performed by the I/O device 508.

To manage communication between components of the processing system 500 (e.g., AU 510, I/O device 508) that are connected to PCI connectors 538, and one or more other components of the processing system 500, the I/O circuitry 512 includes PCI switch 542. The PCI switch 542, for example, includes circuitry configured to route packets to and from the components of the processing system 500 connected to the PCI connectors 538 as well as to the other components of the processing system 500. As an example, based on address data indicated in a packet received from a first component (e.g., CPU 502), the PCI switch 542 routes the packet to a corresponding component (e.g., AU 510) connected to the PCI connectors 538.

Based on the processing system 500 executing a graphics application, for instance, the CPU 502, the AU 510 , or both are configured to execute one or more instructions (e.g., draw calls) such that a scene including one or more graphics objects is rendered. After rendering such a scene, the processing system 500 stores the scene in the storage 514, displays the scene on the display 526, or both. The display 526, for example, includes a cathode-ray tube (CRT) display, liquid crystal display (LCD), light emitting diode (LED) display, organic light emitting diode (OLED) display, or any combination thereof. To enable the processing system 500 to display a scene on the display 526, the I/O circuitry 512 includes display circuitry 544. The display circuitry 544, for example, includes high-definition multimedia interface (HDMI) connectors, DisplayPort connectors, digital visual interface (DVI) connectors, USB connectors, and the like, each including circuitry configured to communicatively couple the display 526 to the I/O circuitry 512. Additionally or alternatively, the display circuitry 544 includes circuitry configured to manage the display of one or more scenes on the display 526 such as display controllers, buffers, memory, or any combination thereof.

Further, the CPU 502, the AU 510, or both are configured to concurrently run one or more virtual machines (VMs), which are each configured to execute one or more corresponding applications. To manage communications between such VMs and the underlying resources of the processing system 500, such as any one or more components of processing system 500, including the CPU 502, the I/O device 508, the AU 510, and the system memory 506, the I/O circuitry 512 includes memory management unit (MMU) 546 and input-output memory management unit (IOMMU) 548. The MMU 546 includes, for example, circuitry configured to manage memory requests, such as from the CPU 502 to the system memory 506. For example, the MMU 546 is configured to handle memory requests issued from the CPU 502 and associated with a VM running on the CPU 502. These memory requests, for example, request access to read, write, fetch, or pre-fetch data residing at one or more virtual addresses (e.g., guest virtual addresses) each indicating one or more portions (e.g., physical memory addresses) of the system memory 506. Based on receiving a memory request from the CPU 502, the MMU 546 is configured to translate the virtual address indicated in the memory request to a physical address in the system memory 506 and to fulfill the request. The IOMMU 548 includes, for example, circuitry configured to manage memory requests (memory-mapped I/O (MMIO) requests) from the CPU 502 to the I/O device 508, the AU 510, or both, and to manage memory requests (direct memory access (DMA) requests) from the I/O device 508 or the AU 510 to the system memory 506. For example, to access the registers 540 of the I/O device 508, the registers 536 of the AU 510, and/or the AU memory 534, the CPU 502 issues one or more MMIO requests. Such MMIO requests each request access to read, write, fetch, or pre-fetch data residing at one or more virtual addresses (e.g., guest virtual addresses) which each represent at least a portion of the registers 540 of the I/O device 508, the registers 536 of the AU 510, or the AU memory 534, respectively. As another example, to access the system memory 506 without using the CPU 502, the I/O device 508, the AU 510, or both are configured to issue one or more DMA requests. Such DMA requests each request access to read, write, fetch, or pre-fetch data residing at one or more virtual addresses (e.g., device virtual addresses) which each represent at least a portion of the system memory 506. Based on receiving an MMIO request or DMA request, the IOMMU 548 is configured to translate the virtual address indicated in the MMIO or DMA request to a physical address and fulfill the request.

In variations, the processing system 500 can include any combination of the components depicted and described. For example, in at least one variation, the processing system 500 does not include one or more of the components depicted and described in relation to FIG. 5. Additionally or alternatively, in at least one variation, the processing system 500 includes additional and/or different components from those depicted. The 500 is configurable in a variety of ways with different combinations of components in accordance with the described techniques.

The example techniques described herein are merely illustrative and many variations are possible based on this disclosure. Although features and elements are described above in particular combinations, each feature or element is usable alone without the other features and elements or in various combinations with or without other features and elements.

The various functional units illustrated in the figures and/or described herein (including, where appropriate, the host 102 having the cores 108 and the memory module 104 having the memory 110 and the processing-in-memory component 120) are implemented in any of a variety of different manners such as hardware circuitry, software or firmware executing on a programmable processor, or any combination of two or more of hardware, software, and firmware. The methods provided are implemented in various devices, such as general-purpose computers, processors, or processor cores. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include read-only memory (ROM), random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system comprising:
a processor configured to:
request a private memory region in memory for data of a first application of multiple applications; and
cause the data of the first application to be stored in the private memory region without encryption, the data not being accessible by other applications of the processor.

2. The system of claim 1, wherein the private memory region of the memory is defined at a page level or as a range of memory addresses.

3. The system of claim 1, wherein the processor is further configured to request a shared memory region accessible by the first application and a second application of the multiple applications.

4. The system of claim 1, wherein the processor is further configured to cause scrubbing of the data in the private memory region in response to an indication that the private memory region has transitioned to a shared memory region.

5. The system of claim 4, wherein the scrubbing is initiated by a compute unit in or near the memory.

6. The system of claim 4, wherein the scrubbing comprises writing zero or one values to each data value in the private memory region.

7. The system of claim 4, wherein the scrubbing comprises writing random values to each data value in the private memory region.

8. The system of claim 4, wherein the processor is further configured to cause scrubbing of the data in the private memory region in response to an indication of a transition of the private memory region from shared memory to private memory.

9. The system of claim 4, wherein access requests to the private memory region are prevented until the scrubbing is completed.

10. The system of claim 9, wherein the access requests are prevented by ordering the access requests to occur after completion of the scrubbing.

11. The system of claim 1, wherein the processor is further configured to establish a trust boundary with a memory system through mutual authentication and attestation.

12. The system of claim 1, wherein the processor is further configured to transfer, on behalf of the first application, the data to the private memory region using link encryption to encrypt the data for transmission over a link between the processor and the private memory region.

13. A method comprising:
receiving, by a processor, a request from a first application to establish a private memory region in memory for data of the first application;
requesting, by the processor, a private memory region for the data of the first application to be established in the memory, the private memory region not being accessible by other applications of the processor; and
causing, by the processor, the data of the first application to be stored in the private memory region in an unencrypted state.

14. The method of claim 13, wherein the method further comprises:
causing, by a memory controller, scrubbing of the private memory region in response to an indication of a power cycling of the memory.

15. The method of claim 14, wherein the scrubbing comprises writing zero values, one values, or random values to each data value in the private memory region.

16. The method of claim 15, wherein the method further comprises:
causing, by the memory, scrubbing of the private memory region in response to a detection of a new attestation and authentication request from the processor.

17. A system comprising:
a host device with one or more processor cores configured to request a private memory region for data of one or more applications of multiple applications; and
a memory device communicatively coupled to the host device, the memory device comprising a memory unit configured to store the data of the one or more applications in a private memory region in an unencrypted format, the data not being accessible by other applications.

18. The system of claim 17, wherein:
the private memory region is distributed across multiple memory units of the memory device; and
the memory device further comprises a compute unit in or near the multiple memory units that is configured to cause scrubbing of the data in the private memory region across the multiple memory units in response to an indication that the private memory region has transitioned to a shared memory region.

19. The system of claim 18, wherein the scrubbing is performed in the multiple memory units in parallel and in response to a single command from one or more processor cores.

20. The system of claim 18, wherein the scrubbing is performed in the multiple memory units for a range of memory addresses associated with the private memory region.
